(19) United States
(12) Patent Application Publication
(10) Pub. No.: US 2009/0014337 A1
(43) Pub. Date: Jan. 15, 2009

(54) Electrochemical Nitrate Destruction

(75) Inventors: Robert Lewis Clarke, Orinda, CA (US); Stephen Harrison, Benicia, CA (US); Salil Jain, Freemont, CA (US)

Correspondence Address: Robert Fish;Fish & Associates, PC, 2603 Main Street, Suite 1050, Irvine, CA, 92614, US

(73) Assignee: APPLIED INTELLECTUAL CAPITAL, Reno, NV (US)

(21) Appl. No.: 10/596,932

(22) PCT Filed: Dec. 20, 2004
(86) PCT No.: PCT/US04/42961

§ 371 Date: Jun. 29, 2006

Related U.S. Application Data
(60) Provisional application No. 60/535,209, filed on Jan. 9, 2004.

(51) Int. Cl. C02F 1/461; C25B 9/00

(52) U.S. Cl. 205/760; 205/742; 204/263

(57) ABSTRACT

Devices and methods are presented for removal and destruction of nitrate from water using an ion exchange medium from which the nitrate is eluted using brine, and in which the so generated eluent is sequentially reduced and oxidized in distinct compartments to form nitrogen from nitrate and ammonia, respectively. In especially preferred devices and methods, the reduced and oxidized eluent is re-reduced to electrochemically destroy hypohalites formed during oxidation. Among other advantages, contemplated devices and methods allow nitrate destruction with minimal concomitant production of nitrite and hypohalites.

This application claims the benefit of U.S. provisional patent application with the Ser. No. 60/535,209, which was filed Jan. 9, 2004, and which is incorporated by reference herein

### FIELD OF THE INVENTION

Electrochemical removal and destruction of contaminants from aqueous media, and especially removal and destruction of nitrate from potable water.

### BACKGROUND OF THE INVENTION

Nitrate levels above a few parts per million in drinking water are general considered an unacceptable health risk. However, many sources of potable water contain even higher levels of nitrate due to agricultural run off, septic tank leach fields, and/or industrial use of nitrates contaminated ground water. While nitrate can be relatively easily removed from water using an ion exchange processes, nitrate released from the columns (e.g., when eluted with brine or alkaline solutions) are often difficult to dispose of and unacceptable for most sewer systems.

To circumvent at least some of the difficulties associated with nitrate-enriched eluents from ion exchange columns, nitrate can be electrochemically reduced to a mixture of nitrite, nitrogen, and/or ammonia at the cathode of an electrochemical cell. Depending on various parameters in the electrochemical reaction (e.g., time, electrode material, current density, concentration of staring electrolyte, etc.), reduction will proceed to a more or less advanced degree with concomitant formation of process intermediates. While direct reduction of nitrate to nitrogen is typically most desired, significant quantities of nitrite are formed in almost all of the known processes as a side product. Unfortunately, nitrite is even more undesirable than nitrate as it tends to generate carcinogens from secondary amines present in natural waters.

Various processes for the reduction of nitrate are discussed in reference texts (e.g., M. Pourbaix and N. de Zoubov in “Atlas d'équilibres électrochimiques à 25° C.”, M Pourbaix, Pub. Gaubier-Villars, Paris, 1963; W. M. Latimer, “The oxidation States of the Elements and their Potentials in Aqueous Solution”, Prentice-Hall, Englewood cliffs, N.J., 1952; or U.S. Pat. No. 3,542,657 to Mindler et al.). Specific electrode materials and electrolyte conditions for this reaction are discussed in WO 00/56666 to Michael Waite. Waite's electrodes are relatively efficient in the electrochemical reduction of nitrate, however, generally require the use of a rhodium or rhodium plated cathode. Unfortunately, rhodium is relatively expensive. Moreover, nitrite formation at the electrode is typically not excluded using such cathodes, and nitrite is typically then thermally decomposed. In other approaches (see e.g. EP 0 291 330 to Croll), electrochemical conditions are carefully adjusted to avoid ammonia formation

In yet another approach, Gilroy teaches in GB 2 267 290 an electrochemical process for the destruction of nitrate using expensive high surface area reticulated vitreous carbon at pH values in excess of 9 in the presence of sodium chloride. The ammonia produced in Gilroy's process is combined with a sodium sulfate solution that is fed to the anolyte chamber of the cell, arid converted to nitrogen at a pH between 1 and 6 using a platinized titanium anode while rigorously excluding the presence of chloride ions. While such an approach is effective in at least some respects, relatively high costs associated with materials in particular the cathode material and operating conditions tend to reduce the attractiveness of such processes.

In a still further known approach, Bradbury et al. describe in U.S. Pat. No. 5,360,400 an electrochemical process of simultaneous reduction of nitrate to nitrogen/ammonia and oxidation of ammonia to nitrogen in a device that includes a central ion exchange resin in fluid communication with an anode chamber and cathode chamber, wherein the anode and cathode chamber are further in fluid communication (or alternatively an auxiliary electrode cathode is disposed in the anode compartment). In such devices, nitrate is electrochemically destroyed to at least some degree. However, various and significant disadvantages remain. Among other things, where anolyte and catholyte are circulated between the compartments, re-oxidation of nitrite to nitrate and of ammonia to nitrite is all but unavoidable. Moreover, elution of nitrate from the ion exchange resin is performed using electrodialysis, which further limits the usefulness of such devices in nitrate destruction (e.g., nitrate ions migrating back into the resin). Velin et al describe two similar but different processes for the destruction on nitrate in ion exchange brine. They describe a process similar to Croll and Gilroy in W/03/074403, except that it would appear they have added the obvious step of adding salt to the system to replace any brine lost on the anion exchanger. In their second patent application WO 02/40406 they describe a process that uses hydroxide ions to displace nitrate from an anion exchange resin rather than the more common sodium chloride brine. They destroy the nitrate to ammonia and nitrogen at the cathode of a divided electrochemical while using another portion of equivalent concentration hydroxide solution in the anolyte compartment of the same electrochemical cell. The catholyte is then transferred to the anolyte compartment and visa-versa. Once the nitrate is substantially destroyed the caustic soda is ready for re-use as a regenerant in the ion change process. The inversing of catholyte and anolyte is designed to balance the concentration of hydroxide ions on either side of the electrochemical cell. The same result is achieved by periodic reversal of the current.

Therefore, while numerous configurations and processes for electrochemical nitrate destruction are known in the art, al or almost all of them suffer from various disadvantages. Thus, there is still a need for improved electrochemical nitrate destruction.

### SUMMARY OF THE INVENTION

The present invention is directed to methods and devices in which nitrate is removed and electrochemically destroyed in a sequential and spatially isolated manner. Contemplated methods and devices are especially advantageous in that they produce only minimal amounts of nitrite and hypohalites.

In one preferred aspect of the inventive subject matter, a method of treating a solution comprising nitrate and a metal halide (erg., sodium chloride) has a step in which the solution is subjected to an electrochemical reduction to thereby reduce the nitrate to ammonia, gaseous nitrogen, and nitrite. In another step, the so treated solution is subjected to an electrochemical oxidation to oxidize the ammonia to nitrogen, the nitrite to nitrate, and the metal halide to a metal hypohalite. In a further step, the oxidized solution is subjected to an electrochemical re-reduction to reduce the metal hypohalite to the metal halide.

It should be especially appreciated that the solution comprising the nitrate and the metal halide may be obtained by eluting an ion exchange column to which nitrate is bound with an eluent that includes a metal halide. Thus, in preferred aspects, the solution obtained after re-reduction may advantageously be employed as circulated eluent. In contemplated methods and devices, nitrate destruction reduces the nitrate concentration of the eluent at least 90% while generating no more than 10 ppm nitrite, and detectable chloramines and free chlorine. Preferred electrode materials include carbon felt for the cathode and platinized titanium for the anode, while the alkalinity of the solution during the electrochemical steps is preferably maintained at a value between pH 7.0 and 9.5.

In another aspect, a method of reducing nitrate concentration in a solution includes one step in which an anion exchange resin is provided having nitrate anions bound thereto. The nitrate anions are preferably eluted with a metal halide eluent to thereby produce an eluent comprising nitrate ions and halide ions. In a further step, the eluent is transferred into a cathode compartment, and the nitrate ions in the eluent are reduced at a cathode to form ammonia ions (and optionally gaseous nitrogen). In still another step, the eluent is transferred after reduction into an anode compartment, and at least some of the ammonia ions are oxidized at the anode to form nitrogen, wherein at another part of the ammonia ions is oxidized using hypohalite ions that are generated at the anode from the halide ions. In a still further step, the hypohalite ions are reduced at the cathode to regenerate the Metal halide eluent.

In a still further contemplated aspect, a device for nitrate destruction may therefore comprise an adsorption unit in which an ion exchange resin is configured to provide a nitrate containing catholyte when the resin is eluted with a solution comprising a metal halide. An electrolytic cell is fluidly coupled to the adsorption unit, and the cell further comprises a cathode compartment having a cathode and an anode compartment having an anode, wherein cathode and anode compartment are separated by a diaphragm. In especially preferred devices, the cathode compartment is configured to receive the catholyte comprising the nitrate and the metal halide, wherein the cathode is configured to reduce nitrate to nitrogen and ammonia to thereby form an anolyte comprising ammonia and the metal halide. A fluid conduit is coupled to the anode compartment and the cathode compartment and configured to transfer the anolyte from the cathode compartment into the anode compartment, wherein the anode in the anode compartment is configured to oxidize the ammonia to nitrogen and the metal halide to a hypohalite.

In another contemplated aspect of the invention, a device for nitrate removal and destruction is contemplated using ion exchange to remove nitrate from solution for potable and other use. The ion exchange resin is once saturated with nitrate switched out of service and eluted with a regenerant normally consisting of sodium chloride brine. The elutant now containing nitrate is then passed through the catholyte compartment of an electrochemical cell and converted to ammonia and nitrogen. The ammonia depending on concentration, pH and temperature will pass into the gas phase and be captured in a gas absorber by the anolyte solution, norms consisting of sulfuric acid but other suitable acids can be used e.g. hydrochloric, methanesulfonic etc . . . The anolyte can then be returned to the anolyte compartment of the electrochemical cell where any ammonia will be destroyed due to the small flux of chloride ions from the catholyte compartment. The chloride ions induce the formation of hypochlorite in the anolyte which reacts rapidly with the ammonia to form chloramines which eventually degrade to nitrogen. The generation of hypochlorite is to some extent accompanied with the formation of chlorine gas, of which some portion will remain gaseous and need scrubbing to prevent its release to the atmosphere. This can be achieved efficiently by use of a portion of the catholyte as the scrubbing solution which will also combine the capture of chlorine and its reaction with ammonia to form chloramines and eventually result in the transformation ammonia to nitrogen.

Various objects, features, aspects and advantages of the present invention will become more apparent from the following detailed description of various preferred embodiments of the invention.

### BRIEF DESCRIPTION OF THE DRAWING

FIG. 1 depicts a schematic diagram of one exemplary configuration for nitrate destruction according to the inventive subject matter.

FIG. 2 is a graph depicting the correlation of the redox potential of the anolyte and ammonia concentration over time.

FIG. 3 depicts a schematic diagram of another exemplary configuration for nitrate destruction according to the inventive subject matter.

FIG. 4 depicts a schematic diagram of a third exemplary configuration for nitrate destruction according to the inventive subject matter.

### DETAILED DESCRIPTION

The inventors discovered various configurations and processes in which nitrate ions are reduced to nitrogen with significantly lowered (if not even abolished) production of toxic and/or corrosive side products (e.g., nitrite, chloramines, etc.) at a remarkably high current efficiency.

In especially preferred aspects of the inventive subject matter, nitrate ions are eluted from an anion exchange column (e.g., AMBERLITE™ IRA-400) using brine (e.g., 15 wt % NaCl solution), and the so formed eluent is then subjected to electrochemical processing in which the eluent is sequentially reduced, oxidized, and (optionally) re-reduced to form a regenerated brine that can be employed for elution of more nitrate ions. It is further preferred that the sequential electrochemical reactions are performed in separate compartments (e.g., reduction in a cathode compartment of an electrochemical cell). Therefore, in at least some of the preferred methods and devices, it should be recognized that the eluent is transferred from a cathode compartment of an electrochemical cell to an anode compartment of the same (or different) electrochemical cell. The step of reduction and the step of oxidation are most preferably performed in an electrochemical cell in which the catholyte comprises the eluent from the ion exchange resin, and the anolyte comprises previously reduced catholyte (i.e., eluent that was previously subjected to electrochemical reduction). However, in alternative aspects, the polarity of the electrodes may be switched, or supplemental electrodes may be used to avoid eluent transfer.

Consequently, in a particularly preferred aspect of the inventive subject matter, the electrochemical nitrate destruction may be performed as described in the below exemplary steps. However, it should be recognized that numerous modifications (including omission of steps) can be made to the presented sequence without departing from the inventive concept presented herein.

### Reduction Of Eluent

Once the brine is eluted (e.g., in batch regeneration of the ion exchange materials), or otherwise provided (e.g., online nitrate removal by reverse osmosis), the nitrate-containing solution is subjected to electrochemical reduction in a electrolytic cell in which cathode and anode compartment are separated (but operationally coupled) via a semipermeable membrane (typically NAFION™ (perfluorosulfonic acid polymer)). The anode compartment preferably includes ammonia-containing brine that was previously treated in the reduction step as described herein.

While the exact electrochemical reactions and events are not entirely understood, it is generally contemplated that in the first reduction step, nitrate is either reduced to ammonia via formation of nitrite (equation (I)) and/or reduced to gaseous nitrogen (i.e., N₂; (equation (II)) with concomitant production of NaOH.

NaNO₃+8e−+8H+=NaOH+NH₄OH+H₂O

NO₃⁻→NO₂⁻→NH₄⁺ (I)

NO₃⁻→N₂ (II)

In particularly preferred processes, relatively inexpensive carbon felt cathodes are employed, which produce ammonia as the main product via nitrite formation as indicated in equation (I). Where such electrodes were used, the inventors unexpectedly observed an unusually high current efficiency along with relatively low yield of ammonia. Therefore, the inventors contemplate that some direct reduction of nitrate to nitrogen as shown in equation (II) may be involved. It was expected that about 50% of the NO₃⁻ is reduced at the cathode to NH₄⁺, while the balance is converted to gaseous nitrogen. This hypothesis is further supported by the fact that reduction of nitrate to nitrogen requires 5 electrons. Under conditions as described below, current efficiencies for this reduction process of over 130% are observed (based on an 8 electron process in Faradic calculations).

### Oxidation Of Reduced Eluent

In further preferred aspects of the inventive subject matter, the treated eluent from the reduction above is subjected to oxidation at an anode (e.g., platinized titanium). It should be especial appreciated that oxidation of the previously reduced eluent is preferably performed in an electrochemical cell in which the cathode compartment is loaded with nitrate-containing brine as described above. Such arrangement will advantageously reduce overall energy consumption as compared with an oxidation step in which the catholyte is a solution other than the nitrate-containing eluent.

Furthermore, it should be recognized that where the eluent comprises NaCl, oxidation of the previously reduced brine will not only result in formation of hypochlorite as shown in equation III, but will also oxidize undesirable nitrite back to nitrate. Thus, several advantages are achieved using contemplated methods and devices: First, oxidation of previously reduced eluent will reduce, if not even completely reduce nitrite that is formed in the reduction step. Second, hypochlorite formed in the oxidation step will assist ammonia degradation in a redox manner as outlined in equation (IV).

2Cl⁻+H₂O+2e⁻→HOCl+HCl (III)

The ammonium ion generated during reduction reacts then with the so generated hypochlorite in a break chlorination reaction as follows:

NH₄^{+OCl}⁻→NH₂Cl+OCl⁻→NHCl₂+OCl⁻→NCl₃+OCl⁻→N₂ (IV)

It should be especially noted that remaining nitrite still present in the solution win be oxidized to nitrate (provided the nitrite is present in relatively low quantities). However, the remaining nitrite is thought to have little or no impact when the treated brine (after at least a step of reduction and oxidation) is used as an eluent to strip the ion exchange resin in successive elutions of nitrate off the column.

### Re-Reduction

It should be recognized that the treated eluent after reduction and oxidation is now substantially free of ammonia and nitrate. However, in at least some instances the so treated eluent should not be used for column regeneration until hypochlorite and/or chloramine ions are neutralized. This is advantageously achieved by electrochemically re-reducing the eluent (e.g., by passing the eluent back through the cathode compartment) until hypochlorite is no longer detected. In a typical re-reduction reaction at the carbon felt cathode, hypochlorite is reduced to a chloride ion and water as outlined in equation (V) below:

OCl⁻2e⁻+2H⁺→Cl⁻+H₂O (V)

Of course, it should be recognized that the eluent need not be limited to a 15 wt % NaCl solution, but numerous modifications may be made. For example, eluents may include one or more metal halides (that are then oxidized to the corresponding metal hypohalites), and/or other competing anions (e.g., carbonates, phosphates, sulfites, etc.) that are effective in displacing nitrate from the ion exchange material. Therefore, suitable concentrations of the anion component in the eluent may range from 0.5 wt % to 50 wt % and even higher. However, in most cases metal halides are present in the eluent at a concentration of between 5 wt % and 25 wt %, and most typically between 10 wt % and 20 wt %. Still further, and especially where the ion exchange material is relatively sensitive to eluents, the nitrate may also be eluted from the ion exchange material via electrodialysis as described, for example, in U.S. Pat. No. 5,306,400. In such cases, NaCl or other metal halides may be added to the eluent during or before the step of oxidation.

With respect to the elution, it should be appreciated that the nitrate may be eluted in a batch-wise manner (e.g., where the ion exchange resin is regenerated) or in continuous fashion. Furthermore, the nitrate-containing solution may also be provided from a source other than an ion exchange resin, and suitable alternative sources include mining waste fluids, agricultural runoff, timber processing, chemical production discharge, fertilizer and explosive manufacture, etc. Typically, the nitrate concentration in the eluent (or other aqueous nitrate-containing fluid) is above about 50 mg/l, more typically at least 500 mg/l, and most preferably at least 1000 mg/l.

Reduction is preferably performed using a high-surface area cathode, in which the surface area is at least 5-times (more typically at least 10 times, and most preferably at least 100 times) the area when calculated as a product of the two largest linear dimensions (e.g., width of the electrode×height of the electrode). Most preferably the cathode will include carbon (e.g., reticulated carbon, carbon felt, etc.), however, numerous alternative materials are also contemplated and especially include those that favor ammonia production over nitrite and/or nitrogen production. Therefore, suitable cathode materials will include ruthenium, ruthenium-coated metals, etc. There are numerous suitable further alternative materials known in the art, and all of the known cathodes materials are deemed suitable for use herein. Similarly, oxidation is preferably performed using a platinized titanium anode. However, it should be appreciated that numerous alternative anode materials are also considered and include various precious metals, and mixtures thereof.

With respect to the pH of the catholyte (typically: eluent with nitrate) and anolyte (typically: reduced eluent), it is generally preferred that the catholyte and anolyte are maintained at a neutral pH to a moderate alkaline pH (i.e., between 8-10). However, where appropriate, the pH may also be adjusted to a slightly acidic pH (e.g. 5.5 to 7.0). The pH can be adjusted using all manners known in the art, and may be controlled on-line, or in predetermined intervals.

Therefore, the inventors contemplate a method of treating a solution comprising nitrate and a metal halide in which in one step the solution is subjected to an electrochemical reduction to thereby reduce the nitrate to ammonia, nitrogen, and nitrite. In a further step, the so treated solution is subjected to an electrochemical oxidation to thereby oxidize the ammonia to nitrogen, the nitrite to nitrate, and the metal halide to a metal hypohalite. In a still further step, the oxidized solution is then subjected to an electrochemical reduction to thereby reduce the metal hypohalite to the metal halide. Most preferably, the eluent is regenerated in that step to allow subsequent elution of nitrate from ion exchange resin.

Of course it should be recognized that all known types of ion exchange resins are deemed suitable, and al of the known such resins are contemplated so long as such resins will bind nitrate in a reversible fashion. Exemplary suitable exchange resins include those listed in the experimental section, and/or Ionac SR-7 or Ionac A-554 from Bayer, or DOWEX M-43 resin from Dow Chemicals. Where nitrate and nitrite are present as salts, suitable ion exchangers include strong base anion exchange resins (e.g., DOWEX 21KXLT or DOWEX is 1), or strong base Type II anion exchange resins like DOWEX MARATHON A2. In still further contemplated aspects, nitrate destruction may also proceed from solid nitrates that are dissolved in an aqueous solution. Alternatively, the nitrate-containing solution may also be derived from other nitrate sequestering operations, including nanofiltration, forward and reverse osmosis.

It should be recognized that each of the individual electrochemical steps may be performed separately in dedicated compartments. However, it is generally preferred that at least two of the three steps are performed in a single electrochemical cell to increase current efficiency of the process. Also, where appropriate, current reversal (or supplemental electrodes of opposite polarity) may be used to avoid transfer of the eluent from one compartment to another. In still further aspects, it is contemplated that at least one of the electrochemical steps may be replaced with a non-electrochemical reduction or oxidation via a redox reaction using an organic and/or inorganic redox partner (in a manner similar to the hypochlorite reaction sequence of the oxidation step).

Moreover, one or more of contemplated electrochemical steps may be eliminated, or alternative process steps introduced. For example, in some instances ammonia is left in the brine stream and the process operated using ammonium chloride as the eluent instead of sodium chloride. Here, care has to be taken to flush the ion exchange column with water so that ammonium is not transferred to the drinking water stream (Such systems would be acceptable where restrictions on ammonia do not apply).

Therefore, a method of reducing a nitrate concentration in a solution may include a step in which an anion exchange resin having nitrate anions bound thereto is provided, and the nitrate anions are eluted with a metal halide eluent to produce an eluent comprising nitrate ions and halide ions. In another step, the eluent is transferred into a cathode compartment and the nitrate ions are reduced in the eluent at a cathode to form ammonia ions and optionally gaseous nitrogen; In yet another step, the eluent is after reduction transferred into an anode compartment and at least some of the ammonia ions are oxidized at the anode to form nitrogen, wherein at least another part of the ammonia ions is oxidized using hypohalite ions that are generated at the anode from the halide ions. The so generated hypohalite ions can then be reduced at the cathode to regenerate the metal halide eluent.

Based on the methods according to the inventive subject matter, the inventors thus contemplate an apparatus that has an adsorption unit (e.g., comprising an ion exchange resin) configured to provide a nitrate-containing catholyte when the resin is eluted with a solution comprising a meal halide. An electrolytic cell is fluidly coupled to the adsorption unit, wherein the cell further comprises a cathode compartment having a cathode and an anode compartment having an anode, and wherein cathode and anode compartment are separated by a diaphragm. In such devices, the cathode compartment is configured to receive the catholyte comprising the nitrate and the metal halide, wherein the cathode is configured to reduce nitrate to nitrogen and ammonia to thereby form an anolyte comprising ammonia and the metal halide. A fluid conduit is coupled to the anode compartment and the cathode compartment and configured to transfer the anolyte from the cathode compartment into the anode compartment, wherein the anode in the anode compartment is configured to oxidize the ammonia to nitrogen and the metal halide to a hypohalite.

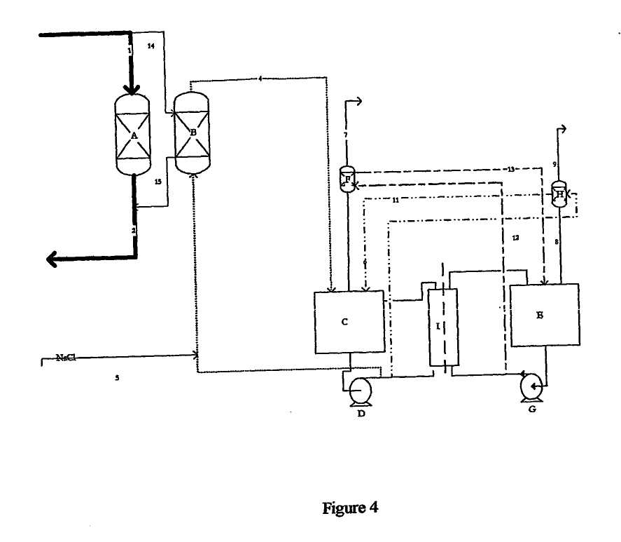

Another preferred configuration is depicted in FIG. 4, a nitrate laded stream is fed through an ion exchange resin bed A via line 1, leaving the ion exchange with nitrate and other ions being removed from the stream The ratio of ion removal is dependent upon the affinity of the ion exchange media Once the capacity of the ion exchange media is reached the bed is switched out of service as depicted by column B. The process of regeneration is to pass brine through the resin through line 3 and leaving the bed through line 4 where it enters the catholyte tank (D) where it is recirculated through the compartment of a divided electrochemical cell (I). Through the anolyte compartment of the electrochemical cell an acid solution is re circulated from tank (E). At the same time the anolyte solution is recirculated through gas absorber (F) to capture any ammonia gas generated via the reduction of nitrate aqt the cathode. Equally the catholyte solution is recirculated through gas absorber (H to capture any soluble off gases generated at the anode. In particular though the electrochemical cell is divided by a cation exchange membrane and its performance is exceptional, it cannot prevent, despite the teachings of Gilroy entirely, the flux of anions from the catholyte compartment to the anolyte compartment. As a consequence of the flux of anions for example chloride or other halide will concentrate in the anolyte compatriot and will be converted to hypochlorite or chlorine gas which will in turn be captured in gas absorber (H) and react with ammonia to generate nitrogen. Equally and hypochlorite will react with dissolved ammonia in the anolyte which will also ultimately generate nitrogen gas. Once all or part of the nitrate in the catholyte has been destroyed it can be reused to regenerate the once again saturated ion exchange resin. The brine will be come depleted with use due to displacement of chloride ions from the ion exchange media

### EXAMPLE

The following examples are provided to illustrate various devices and methods of nitrate removal and destruction according to the inventive subject matter. However, it should be understood that numerous variations may be made without departing from the inventive concept presented herein.

### Nitrate Removal

A chromatography column was loaded with 2000 ml of an anion exchange resin slurry (AMBERLITE™ IRA-400 styrene gel resin) having approximately 0.9 meq/ml binding capacity for nitrate. The nitrate was loaded onto the ion exchange resin from a sodium nitrate solution (about 50 liter at 0.1M NaNO₃) that was passed through the column overnight at relatively slow rate. The eluent of the column was periodical checked for unbound nitrate and determined to be below 1 mM. The nitrate was substantially completely eluted from the column using an aqueous solution containing 15 wt % NaCl.

### Reduction Of Nitrate

29 liter of a solution containing 1025 mg/l of NO₃⁻ and 15 wt % NaCl was circulated through the cathode compartment of a divided electrochemical cell. The anode compartment was charged as described in the section below entitled “Oxidation of Ammonia”, and anode and cathode compartments were separated by a NAFION™ membrane. Alternatively, dilute sulfuric acid may be used as anolyte.

Constant current of 50 A was passed through the cell via a carbon felt high surface area cathode. The temperature was in the range of 30 to 40° C., and the pH was maintained at about 9.0 in the cathode compartment by addition of diluted HCl. The current density at the cathode was around 1250 A/m². The NO₃⁻ concentration in the cathode compartment was periodically monitored, and after about 390 minutes, the NO₃⁻ concentration was reduced to 95 mg/l. Based on this reduction, cumulative current efficiency was calculated at about 77% (for a five-electron reduction of NO₃⁻ to N₂) or 123% (for an eight-electron reduction of NO₃⁻ to NH₄⁺). The energy consumption per g of NO₃⁻ destroyed in this step (i.e., reduction of NO₃⁻ from 1025 mg/l to 95 mg/l) is estimated to be 0.068 Kwh.

### Oxidation Of Ammonia

17 liters of a solution containing 1013 mg/l of NH₄⁺ and 8 wt % NaCl was circulated through the anolyte compartment of the divided electrochemical cell described above. The cathode compartment was charged as described in the section entitled “Reduction of Nitrate” above.

A constant current of 50 A was passed through the cell. The temperature was in the range of 32 to 43° C., while the pH in the anode compartment was maintained at around 7.0 by addition of a NaOH solution. The current density was around 1250 A/m². The NH₄⁺ concentration in the anode compartment was periodically monitored, and after about 66 minutes, the concentration of NH₄⁺was reduced to 27 mg/l. Based on this reduction, the cumulative current efficiency was calculated to about 146% (for a three-electron oxidation of NH₄⁺ to N₂). The high current efficiency can be explained by the conversion of part of the NH₄⁺ into chloramines, which may contribute to break chlorination.

It should be noted that no energy is consumed in this step provided that the oxidation of ammonia to nitrogen is performed in the opposite cell where concurrently nitrate is reduced to ammonia. Furthermore, it is estimated that the NO₂⁻ (e.g., formed during the reduction) and some of the NH₄⁺ will oxidize back to NO₃⁻ in this oxidative step as evidenced by an increase in overall nitrate concentration from 95 mg/l (see above) to about 127 mg/l.

### Re-Reduction Of Eluent

10 liter of the treated solution from the step above entitled “Oxidation of Ammonia” were circulated in the catholyte tank for a about 60 minutes at conditions substantially as described above. It was observed that free chlorine was reduced from 140 mg/l to levels that were undetectable, while the total chlorine level was reduced from 1160 mg/l to about 1 mg/l. Concurrently with the oxidation of chlorine and chloramines, this step is used for reduction of the NO₃⁻ to the desired level. The energy consumption per g of NO₃⁻ destroyed for this step (here: reducing the NO₃⁻ from 127 mg/l to 7 mg/l ) is estimated to be 0.196 kWh.

Therefore, exemplary devices and methods were demonstrated to reduce the nitrate concentration of a nitrate-containing solution to levels below 10 mol % of such solutions after sequential electrochemical processing. However, more typically levels of less than 5 mol %, and even less than 2 mol % can be achieved using such methods and devices. Remarkably, the levels of nitrite are typically less than 300 ppm, more typically less than 30 ppm, and most typically less than 10 ppm

### Configurations With ORP Control And Without Re-Reduction

An exemplary integrated process flow is depicted in FIG. 1, in which during typical operation groundwater contaminated with nitrate and other species is circulated through an ion-exchange column C1. Once loaded, the column will be switched to a parallel second column C2 and groundwater will be passed through the second column C2. A brine solution is circulated through column C1 to displace bound nitrate and other ions from the column. The so obtained solution of spent brine from the regeneration of the ion exchange column contains a mixture of nitrate, sulfate bicarbonate and other anions present in the ground or water to be purified (1a and 1b) and is fed to two electrochemical cells (A & B).

In the electrochemical cells, the solution of spent brine is subjected to electrochemical reduction at a pH greater than 4, where the nitrate is reduced electrochemically to nitrogen and ammonia. The reaction is most preferably carried out at a pH between 7 and 10. Among other things, under acidic conditions the inventors observed typically more competition with hydrogen evolution at the cathode, and at a pH greater than 10 significant vaporization of ammonia into the atmosphere is often observed.

The electrochemical cell used for ammonia destruction preferably comprises a high surface area carbon felt electrode, although other electrodes materials may also be used. The electrochemical cell is further preferably divided by a separator or a membrane that reduces (or better eliminates) flux of reduced species to the anode to undergo oxidation. At the anode of electrochemical cell (A), oxygen is evolved on anodes comprising platinized-titanium, platinum-iridium and/or iridium oxide (preferably deposited in thin micron or sub-micron on a stable substrate, including titanium, tantalum, Ti₄O₇, Ti_{0.9}Nb_{0.1}O₂, etc.). The electrolyte in the anolyte of the electrochemical cell (A) is preferably inert to electrochemical oxidation, and typically comprises methanesulfonic acid or sulfuric acid.

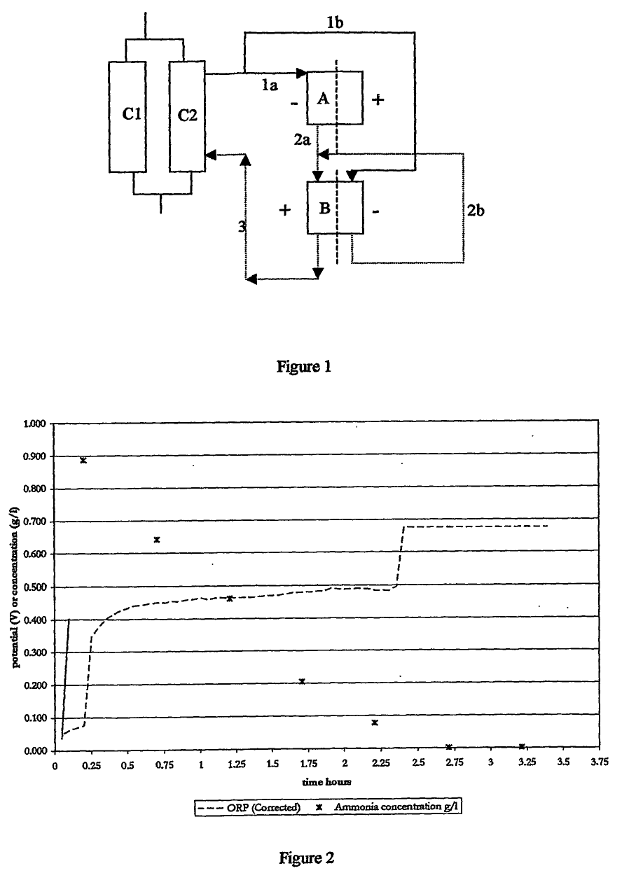

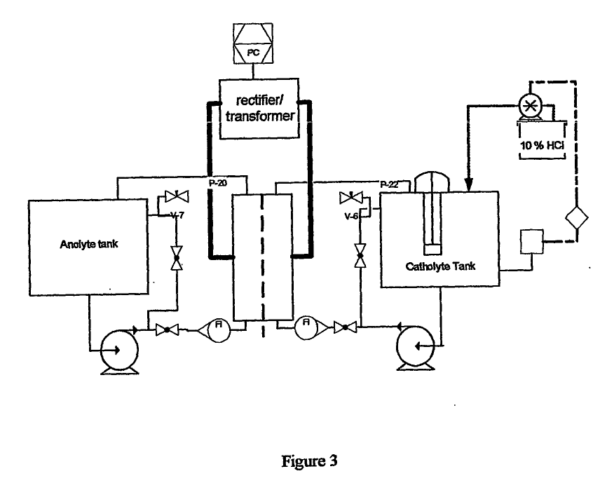

Once the nitrate in spent solution is converted to nitrogen and ammonia in cell (A), the solution is transferred to the anode compartment of electrochemical cell (B) via line 2a and 2b where the dissolved ammonia is destroyed by generating hypochlorite using anode materials as described above for cell (A). At the cathode of electrochemical cell (B), a second portion of the solution is undergoing nitrate destruction per the description for cell (A). Once again the electrochemical cell (B) is divided to limit the flux of oxidized and reduced species to the cathode and anode sure and undergoing undesired reactions. The progress of ammonia destruction in electrochemical cell (B) is monitored by way of an electrochemical probe (ORP (oxygen reduction potential) electrode) which indicates the extent of the ammonia degradation and the formation of hypochlorite in solution. As indicated in FIG. 2, destruction of ammonia (typically to a level below 0.1 mg/ml) is accompanied by a sharp increase in the ORP.

It is therefore possible to prevent the formation of excess hypochlorite by stopping the electrolysis using ORP control. Once electrochemical treatment of the brine is finished, the brine solution is ready to regenerate another ion exchange column (C2). Additional treatment procedures may be combined with the electrochemical process to remove sulfate, bicarbonate and other anions ions from the brine. For example, the brine can be treated with calcium chloride or barium sulfate to precipitate sulfate as calcium or barium sulfate, and acidified to convert carbonate and bicarbonate to carbon dioxide. Other treatments contemplated include nanofiltration, which is known to remove sulfate from brine solutions.

### Exemplary Pilot Plait With ORP Control

The equipment of an exemplary pilot plant included a pilot scale electrochemical cell with an active surface area 0.04 m², comprising one graphite felt cathode, one platinized titanium anode, and a NAFION™ Membrane, installed in a test rig as shown in FIG. 3. The test rig included two flow circuits, each including a tank, a pump, a flow meter, and pH controller. The electrochemical cell was powered by a rectifier transformer.

(I) The anolyte was 10% sulfuric acid, while the catholyte consisted of 36 liters of sodium chloride brine (15% wt/vol) to which 6500 ppm of nitrate was added as sodium nitrate), 4000 ppm of sulfate as sodium sulfate, and 1000 ppm of bicarbonate as sodium bicarbonate. The catholyte was initially heated to 35° C. while the solutions were re-circulated via a cell by-pass loop. Both anolyte and catholyte were then allowed to pass through the cell at flow rate of 4 gal/min. The pH of the catholyte was initially 1.8 and its pH was adjusted to 8.6 by the addition of sodium bicarbonate before a current of 50 A was applied. The pH of the catholyte was controlled by the addition of hydrochloric acid (10% wt/vol). The total amount of acid added was 1.25 liters. The experiment lasted 20 hours until the nitrate was destroyed to a level below 1 ppm The cell voltage varied between 4.9 and 4.5 V, and the energy consumption was 17.2 kWh/kg of nitrate destroyed (the specific area of electrode was 2.9 m₂/(kg/hr)). The observed Faradic efficiency for the production of ammonia was 59% of the current passed with 22% forming nitrogen and 19% forming hydrogen over the range of concentration 6800 to 180 mg/l nitrate, correlating to an overall useful Faradic efficiency of 81%.

(II) The electrolyte re-circulation loops were modified so that the solution from the catholyte tank was pumped through the anode side of the cell and the solution from anolyte tank (10% sulfuric acid) was replaced by a fresh solution of 27 liters of brine containing 6.2 g/l nitrate as sodium nitrate (the circuit was thoroughly rinsed before the new catholyte was introduced.) The anolyte was heated to 35° C. as before and the pH was adjusted to 9 on both sides of the cell. A current of 50 A was applied, and an average cell voltage of 4.2 V was observed. The initial ammonia concentration was 880 mg/l and the ammonia concentration was below the detection limit after 2.71 hours.

The progress of the reactions was followed using a DOWEX ion chromatography system equipped with AS11/AG11 column was used to analyze nitrate, chloride, sulfate and nitrite. The same system equipped with CS12A(CG12A column was used to a ammonia The energy consumption was 17.2 kWh/g of nitrate destroyed, and the specific area of electrode is 2.9 m²/(kg/hr) The observed Faradic efficiency for the production of ammonia is 59% of the current passed with 22% forming nitrogen and 19% forming hydrogen over the range of concentration 6800 to 180 mg/l nitrate, an overall useful Faradic efficiency of 81%.

Further studies indicated (data not shown) that the progress of ammonia destruction was about 100% efficient between 880 mg/l and 200 mg/l, followed by a drop in efficiency to about 60% between 200 and 100 mg/l, and 37% between 100 and 0 mg/l. The overall Faradic efficiency is 81% with an average cell voltage is 4.19 V. The progress of the reduction was followed using ORP measurement, demonstrating an excellent indication of complete ammonia destruction. Chemical analyses showed that once ammonia was destroyed, free hypochlorite is formed, which is detected by the ORP electrode as higher potentials. The catholyte compartment was successfully operated at an overall Faradic efficiency of 122% for a 8 electron transfer with an energy consumption of 11.9 kWh/kg of nitrate and a specific surface area of 2.0 m²/(kg/hr).

0.87 moles of nitrate were destroyed generating 0.47 moles of ammonia. It is assumed that the remaining 0.4 moles of nitrate were converted into 0.2 moles of nitrogen. The true Faradic efficiencies were therefore calculated to be 66.7% for ammonia production and 34.5% for nitrogen production in the 6200 to 4200 mg/l range of nitrate concentration. At the end of the nitrate destruction part of the experiment the ammonia concentration was 1200 mg/l, concentration fell to 880 mg/l due to evaporation and some dilution during the transfer in flow circuits. The number of electrons transferred for this reaction per mole of ammonia destroyed is 3 compared to the 8 for the transformation of nitrate to ammonia. Only 59% of the nitrate is converted to ammonia. The percentage of cells that would destroy ammonia can be calculated by the formula:

S_{S}=S_{N}*zₐ/zₙ*φₙ/φₐ,

where z is electrons, φ is efficiency, and S is surface area, and where A is ammonia and N is name. By this calculation, the percentage of nitrate reduction cells that also destroy ammonia is 27%, by this calculation 0.8 m²/(kg/hr) relative to the total surface area of 2.9 m₂/(kg/hr). The energy consumption for both nitrate and ammonia destruction by weighted average is 16.7 kWh/kg nitrate (27% of the cells would have an energy consumption of 15.5 kWh/kg and 73% of the cells would operate at 17.5 kWh/kg, over the range of 6800 mg/l to 180 mg/l).

Thus, specific embodiments and applications of electrochemical nitrate destruction have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of treating a solution comprising nitrate and a metal halide, comprising:
(I) subjecting the solution to an electrochemical reduction to thereby reduce the nitrate to ammonia, nitrogen, and nitrite,
(II) subjecting the solution from step (I) to an electrochemical oxidation to thereby oxidize the ammonia to nitrogen, the nitrite to nitrate, and the metal halide to a metal hypohalite; and
(III) using monitoring an oxidation/reduction potential of the solution as an indicator to discontinue oxidation of step (II) to prevent hypohalite formation exceeding a predetermined concentration, or selecting the solution from step (II) to an electrochemical reduction to thereby reduce the metal hypohalite to the metal halide.

2. The method of claim 1 further comprising a step of eluting an ion exchange column to which nitrate is bound with an eluent that includes a metal halide to thereby form the solution comprising the nitrate and the metal halide.

3. The method of claim 2 further comprising a step of using the solution comprising the metal halide from step (III) to elute the nitrate from the ion exchange resin.

4. The method of claim 1 wherein the solution comprising the metal halide from step (II) comprises less than 10 mol % of the nitrate contained in the solution of step (I) before reduction, and less than 10 ppm nitrite.

5. The method of claim 1 wherein at least one of steps (I)+(III) and steps (I)+(II) are performed in a single electrochemical compartment.

6. The method of claim 1 wherein reduction is performed using an electrode comprising carbon felt.

7. The method of claim 1 wherein oxidation is performed using an electrode comprising platinized titanium.

8. The method of claim 1 wherein alkalinity of the solution in steps (I), (II), and (III) is maintained at a value between pH 7.0 and 9.5.

9. A method of reducing a nitrate concentration in a solution, comprising:
providing an anion exchange resin having nitrate anions bound thereto, and eluting the nitrate anions with a metal halide eluent to thereby produce an eluent comprising nitrate ions and halide ions;
transferring the eluent into a cathode compartment and reducing the nitrate ions in the eluent at a cathode to form ammonia ions and optionally gaseous nitrogen;
transferring the eluent after reduction into an anode compartment and oxidizing at least some of the ammonia ions at the anode to form nitrogen, wherein at least another part of the ammonia ions is oxidized using hypohalite ions that are generated at the anode from the halide ions; and reducing the hypohalite ions at the cathode to regenerate the metal halide eluent.

10. The method of claim 9 wherein the step of reducing the nitrate ions produces at least some nitrite ions, and wherein the nitrite ions are oxidized back to nitrate at the anode in the step of oxidizing.

11. The method of claim 9 further comprising a step of using the regenerated metal halide eluent to elute further nitrate ions from the ion exchange resin.

12. The method of claim 9 wherein the step of reducing and oxidizing are performed in a cathode and anode compartment that are coupled to each other via a diaphragm.

13. The method of claim 9 wherein the cathode comprises a carbon felt and the anode comprises platinized titanium.

14. The method of claim 9 wherein the metal halide is sodium chloride.

15. The method of claim 9 wherein alkalinity of the eluent is maintained at a value between pH 7.0 and 9.5.

16. An apparatus comprising:
an adsorption unit comprising an ion exchange resin configured to provide a nitrate-containing catholyte when the resin is eluted with a solution comprising a metal halide;
an electrolytic cell fluidly coupled to the adsorption unit the cell further comprising a cathode compartment having a cathode and an anode compartment having an anode, wherein cathode and anode compartment are separated by a diaphragm;
wherein the cathode compartment is configured to receive the catholyte comprising the nitrate and the metal halide, and wherein the cathode is configured to reduce nitrate to nitrogen and ammonia to thereby form an anolyte comprising ammonia and the metal halide;
a fluid conduit coupled to the anode compartment and the cathode compartment and configured to transfer the anolyte from the cathode compartment into the anode compartment; and
wherein the anode in the anode compare is configured to oxidize the ammonia to nitrogen and the metal halide to a hypohalite.

17. The apparatus of claim 16 wherein alkalinity of the eluent is mated in the electrolytic cell at a value between pH 7.0 and 9.5.

18. The apparatus of claim 16 wherein the electrolytic cell is a retrofit to the adsorption unit.

19. The apparatus of claim 16 wherein the cathode comprises a carbon felt.

20. The apparatus of claim 16 wherein the anode comprises platinized titanium.

21. A method of treating a solution comprising nitrate and a metal halide, comprising:
(I) subjecting the solution to an electrochemical reduction to thereby reduce the nitrate to ammonia, nitrogen, and nitrite;
(II) subjecting the gases evolved from the catholyte during step (I) to an absorption step using the anolyte of step (I) to capture the ammonia gas and then subjecting said anolyte to electrochemical oxidation to thereby oxidize the ammonia to nitrogen, and the metal halide to a metal hypohalite; and
(III) using monitoring an oxidation/reduction potential of the solution as an indicator to discontinue oxidation of step (II) to prevent hypohalite formation exceeding a predetermined concentration, or subjecting the solution from step (II) to an electrochemical reduction to thereby reduce the metal hypohalite to the metal
(IV) using a portion off the catholyte solution from step (I) to capture off gases from step (II) and then subjecting that solution to electrochemical reduction.
